(19) United States
(12) Patent Application Publication
(10) Pub. No.: US 2025/0135968 A1
(43) Pub. Date: May 1, 2025

(54) CHILD CAR SEAT ELLIPSOIDAL PATH SYSTEM

(71) Applicant: Britax Child Safety, Inc., Fort Mill, SC (US)

(72) Inventors: Michael Fuerstenberg, Ulm (DE); Dan Ross, Vadnais Heights, MN (US); Quentin Walsh, Fort Mill, SC (US); Angela Stacey, St. John’s (CA)

(73) Assignee: Britax Child Safety, Inc., Fort Mill, SC (US)

(21) Appl. No.: 18/932,262

(22) Filed: Oct. 30, 2024

Related U.S. Application Data
(60) Provisional application No. 63/594,780, filed on Oct. 31, 2023.

(51) Int. Cl. B60N 2/28

(52) U.S. Cl. CPC B60N 2/2821; B60N 2/2869

(57) ABSTRACT

Example systems, methods, and apparatus are disclosed herein for a child car seat system implementing an ellipsoidal path. A child car seat system includes a base, a child seat, and an ellipsoidal path system. The ellipsoidal path system includes at least a track member, affixed to the base, and a carriage, affixed to the child seat. The carriage is configured to translate and rotate relative to the track member.

### PRIORITY CLAIM AND CROSS-REFERENCE TO RELATED APPLICATIONS

The present application claims priority to and benefit of U.S. Provisional Patent Application No. 63/594,780 filed Oct. 31, 2023, titled “CHILD CAR SEAT ELLIPSOIDAL PATH SYSTEM,” the entire contents of which is are incorporated by reference herein in their entirety and relied upon.

### BACKGROUND

Child car seats allow caregivers to safely transport children in a vehicle. That said, child car seats can be difficult to access, particularly when buckling and unbuckling children. Accessibility issues are primarily due to the oversized dimensioning of the car seats themselves. In an attempt to solve this issue, certain child car seats can be secured to a rotating base that swivels about a center point or axis; caregivers can turn the child car seat towards the car door in order to buckle and unbuckle children, providing improved access. These child car seat and rotating base systems are often difficult to rotate and are directionally limited as they are only capable of rotating about a single center point or axis. When rotating about the center point, these existing systems may disturb other child car seats or adult occupants in adjacent seating positions. Accordingly, a need exists for a child car seat that allows caregivers to rotate the child car seat such that it faces outward towards the car door, while simultaneously providing sufficient clearance so as to not disturb adjacently seated occupants or other child car seats.

### SUMMARY

Example systems, methods, and apparatus are disclosed herein for a child car seat system implementing an ellipsoidal path.

Aspects of the subject matter described herein may be useful alone or in combination with one or more other aspects described herein. In light of the disclosure set forth herein, and without limiting the disclosure in any way, in a first aspect of the present disclosure, which may be combined with any other aspect, or portion thereof, a child car seat system includes a base, a child seat, and an ellipsoidal path system. The ellipsoidal path system includes at least a track member, affixed to the base, and a carriage, affixed to the child seat. The carriage is configured to translate and rotate relative to the track member.

In a second aspect of the present disclosure, which may be combined with any other aspect, or portion thereof, the carriage includes a first vertical member and a second vertical member. Each of the first vertical member and the second vertical member are configured to slidingly engage with the track member.

In a third aspect of the present disclosure, which may be combined with any other aspect, or portion thereof, the first vertical member and the second vertical member have different lengths, such that the first vertical member engages with the track member at a first height and the second vertical member engages with the track member a second height, different from the first height.

In a fourth aspect of the present disclosure, which may be combined with any other aspect, or portion thereof, the track member includes four side rails that collectively form a concave square shape.

In a fifth aspect of the present disclosure, which may be combined with any other aspect, or portion thereof, a cross rail bisects the concave square shape.

In a sixth aspect of the present disclosure, which may be combined with any other aspect, or portion thereof, the track member includes a four-pointed, concave-sided star shape.

In a seventh aspect of the present disclosure, which may be combined with any other aspect, or portion thereof, a cross rail bisects the four-pointed, concave-sided star shape.

In an eighth aspect of the present disclosure, which may be combined with any other aspect, or portion thereof, the carriage is lockable, relative to the track member, such that, when locked, the carriage cannot translate or rotate relative to the track member.

In a ninth aspect of the present disclosure, which may be combined with any other aspect, or portion thereof, the child seat is configured to rotate from a front-facing or rear-facing position to a side-facing position.

In a tenth aspect of the present disclosure, which may be combined with any other aspect, or portion thereof, when the child seat rotates, the child seat also translates toward a loading position. Translation toward a loading position is in a direction normal to the direction of vehicular travel.

In an eleventh aspect of the present disclosure, which may be combined with any other aspect, or portion thereof, the carriage includes a slot, extending from a first end of the carriage to a second end of the carriage.

In a twelfth aspect of the present disclosure, which may be combined with any other aspect, or portion thereof, the slot is configured to receive a post disposed along the track member.

In a thirteenth aspect of the present disclosure, which may be combined with any other aspect, or portion thereof, track member is oval shaped, with a circular portion extending from a side of the oval shape.

In a fourteenth aspect of the present disclosure, which may be combined with any other aspect, or portion thereof, a child car seat system includes a child seat and an ellipsoidal path system. The ellipsoidal path system includes at least a track member having a post, and a carriage, affixed to the child seat. The carriage includes a slot, extending from a first end of the carriage to a second end of the carriage. The slot is configured to receive the post.

In a fifteenth aspect of the present disclosure, which may be combined with any other aspect, or portion thereof, the carriage is configured to translate and rotate relative to the track member.

In a sixteenth aspect of the present disclosure, which may be combined with any other aspect, or portion thereof, the carriage is lockable, relative to the track member, such that, when locked, the carriage cannot translate or rotate relative to the track member.

In a seventeenth aspect of the present disclosure, which may be combined with any other aspect, or portion thereof, the child seat is configured to rotate from a front-facing or rear-facing position to a side-facing position.

In an eighteenth aspect of the present disclosure, which may be combined with any other aspect, or portion thereof, when the child seat rotates, the child seat also translates toward a loading position. Translation toward a loading position is in a direction normal to the direction of vehicular travel.

In a nineteenth aspect of the present disclosure, which may be combined with any other aspect, or portion thereof, the track member is oval shaped, with a circular portion extending from a side of the oval shape.

In a twentieth aspect of the present disclosure, which may be combined with any other aspect, or portion thereof, the carriage includes a first vertical member configured to slidingly engage with the track member.

Additional features and advantages are described in, and will be apparent from, the following Detailed Description and the Figures. The features and advantages described herein are not all-inclusive and, in particular, many additional features and advantages will be apparent to one of ordinary skill in the art in view of the figures and description. In addition, any particular embodiment does not have to have all of the advantages listed herein and it is expressly contemplated to claim individual advantageous embodiments separately. Moreover, it should be noted that the language used in the specification has been selected principally for readability and instructional purposes, and not to limit the scope of the inventive subject matter.

### BRIEF DESCRIPTION OF THE FIGURES

The specification makes reference to the following appended figures, in which use of like reference numerals in different figures is intended to illustrate like or analogous components.

FIG. 1 is a top view of a child car seat ellipsoidal path system in extended position, according to an example embodiment of the present disclosure.

FIG. 2 is a top view of a child car seat ellipsoidal path system in non-extended position, according to an example embodiment of the present disclosure.

FIG. 3 is a side perspective view of a long end of a central rail, according to an example embodiment of the present disclosure.

FIG. 4 is a side perspective view of a carriage coupled to a child car seat, according to an example embodiment of the present disclosure.

FIG. 5 is a top view of a child car seat ellipsoidal path system in use with a child car seat, according to an example embodiment of the present disclosure.

FIG. 6 is a top perspective view of a child car seat ellipsoidal path system track coupled to a child car seat base, according to an example embodiment of the present disclosure.

FIG. 7 is a top perspective view of a child car seat ellipsoidal path system coupled to a child car seat base, according to an example embodiment of the present disclosure.

FIG. 8 is a top perspective view of a child car seat ellipsoidal path system coupled to a child car seat base and to a seat coupler, according to an example embodiment of the present disclosure.

FIGS. 9A-9C are bottom-up views of various configurations of a carriage coupled to a track member, according to an example embodiment of the present disclosure.

FIGS. 10A-10C are top perspective views of a child car seat ellipsoidal path system in use with a child car seat, according to an example embodiment of the present disclosure.

FIG. 11 is a top perspective view of a child car seat ellipsoidal path system track and carriage, according to an example embodiment of the present disclosure.

FIG. 12 is a top perspective view of a child car seat ellipsoidal path system track, according to an example embodiment of the present disclosure.

FIG. 13 is a top perspective view of a child car seat ellipsoidal path system carriage, according to an example embodiment of the present disclosure.

FIG. 14 is a side view of a child car seat ellipsoidal path system carriage, according to an example embodiment of the present disclosure.

### DETAILED DESCRIPTION

The subject matter of embodiments is described herein with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described. Directional references such as “up,” “down,” “top,” “bottom,” “left,” “right,” “front,” and “back,” among others, are intended to refer to the orientation as illustrated and described in the figure (or figures) to which the components and directions are referencing. Throughout this disclosure, a reference numeral with a letter refers to a specific instance of an element and the reference numeral without an accompanying letter refers to the element generically or collectively. Thus, as an example (not shown in the drawings), device “12A” refers to an instance of a device class, which may be referred to collectively as devices “12” and any one of which may be referred to generically as a device “12.” In the figures and the description, like numerals are intended to represent like elements.

Methods, systems, and apparatus are disclosed herein for a child car seat ellipsoidal path system.

While the example methods, apparatus, and systems are disclosed herein a child car seat ellipsoidal path system, it should be appreciated that the methods, apparatus, and systems may be operable for other applications such as child seats in event arenas or in air transportation.

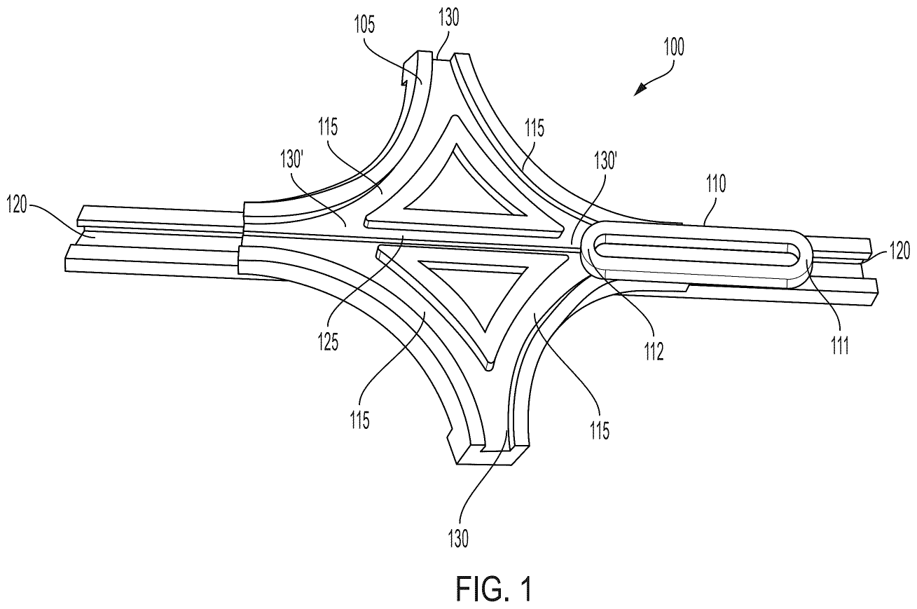

FIG. 1 is a top view of a child car seat ellipsoidal path system 100 in extended position. As seen in FIG. 1, the child car seat ellipsoidal path system 100 includes a track member 105 and a carriage 110. The track member 105 includes four side rails 115 that have curvilinear shapes. The four side rails 115 are the same length and arranged such that each rail end converges with another rail end at a rail convergence point 130. As such, the side rails 115 form a concave square shape with rail convergence points 130. Additionally, as seen in FIG. 1, the track member 105 includes a central rail 125 with two long ends 120. The central rail 125 bisects the concave square shape defined by the four rails 115. Specifically, the central rail 125 aligns with and runs across two convergence points 130′. Moreover, the length of the central rail exceeds the length between the two convergence points 130′, such that the two long ends 120 flank the two convergence points 130′. In turn, the track member 105 is symmetrical along the plane created by the central rail 125, and is symmetrical along a perpendicular plane corresponding with convergence points 130.

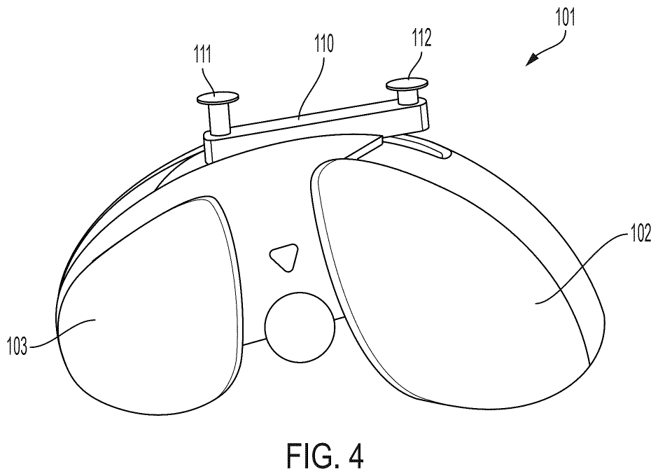

The carriage 110 includes a deep member 111 and a shallow member 112 (illustrated more clearly by FIG. 4). The carriage 110 is movably coupled to the track member 105, such that it slides along track member 105. Specifically, the deep member 111 and shallow member 112 of the carriage 110 are slidably coupled to the central rail and the side rails 115, respectively, such that the carriage 110 is slidable on the side rails 115 and central rail 125, as further detailed below. In an embodiment, the deep member 111 and shallow member 112 of carriage 110 are “lockable” in a given position along any of side rails 115 and central rail 125. Namely, when in an “unlocked” state, the deep member 111 and shallow member 112 of carriage 110 freely slide within the side rails 115 and central rail 125; in a “locked state, the deep member 111 and shallow member 112 of carriage 110 are fixed at given positions within the side rails 115 and/or central rail 125, such that deep member 111 and shallow member 112 cannot slide in the “locked” state. Thus, when locked, carriage 110 cannot rotate or translate relative to track member 105.

Furthermore, carriage 110 can be arranged on track member 105 in either an extended or a non-extended configuration. As illustrated by FIG. 1, the system 100 in an extended configuration, whereby one of the deep member 111 or shallow member 112 is located near one of the long ends 120 of the central rail 125; in this extended configuration, the carriage 110 is disposed on the long end 120 of the central rail 125, such that the carriage 110 is parallel to the long end 120.

It should be appreciated that the system 100 is generally configured to be coupled to a child car seat base such that, for example, the track member 105 is coupled to a child car seat base and the carriage 110 selectively couples to a child car seat. In turn, caregivers can selectively couple the carriage 110 to track member 105 when selectively coupling the child car seat to the child car seat base. Relatedly, the track member 105 is coupled to the child car seat base such that one of the long ends 120 faces the car door when the child car seat base is installed. Therefore, when the system 100 is disposed in an extended configuration, the child car seat both rotates towards a side door of a vehicle and extends outwardly towards the side door of the vehicle (e.g., during active loading/unloading).

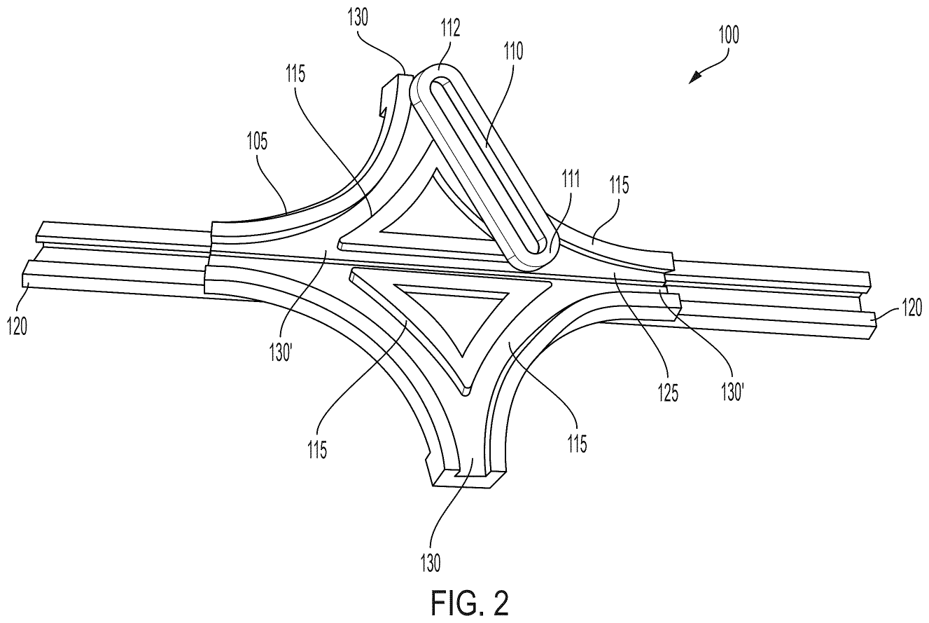

FIG. 2 is a top view of a child car seat ellipsoidal path system 100 in a non-extended position. When the system 100 is disposed in the non-extended configuration, one of the deep member 111 or shallow member 112 of the carriage 110 is located near one of the four rail convergence points 130. As such, when the system is in the non-extended configuration, the child car seat does not extend outwardly towards the car door; rather, in the non-extended configuration, the child car seat is disposed about the center of the car seat base (e.g., during travel) in either a forward-facing or rear-facing configuration.

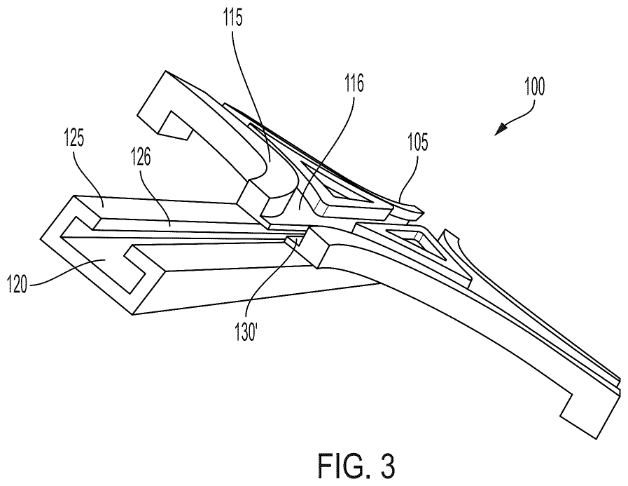

FIG. 3 is a side perspective view of a long end of a central rail 125. As seen in FIG. 3, in the track member 105, the central rail 125 has a central depth 126 and the side rails 115 have side depth 116.

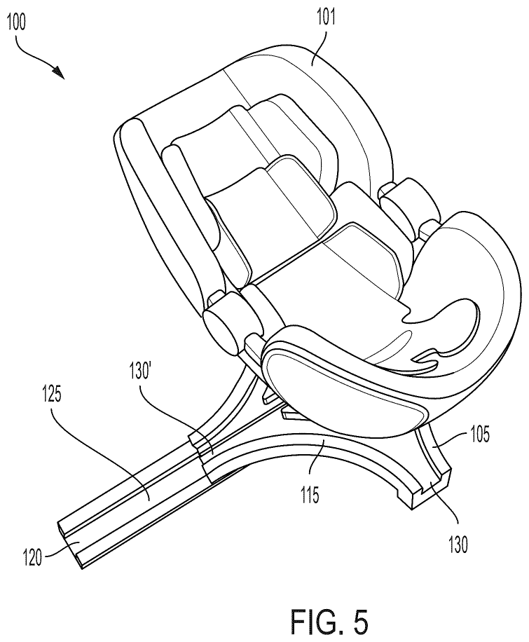

Relatedly, FIG. 4 shows a side perspective view of a carriage 110 coupled to a child car seat 101. In the preferred embodiment, the carriage 110 is coupled to the child car seat 101 such that the deep member 111 faces the child car seat front 103 and the shallow member 112 faces the child car seat rear 102. Moreover, in use, the deep member 111 is slidably coupled with the central rail 125, such that the deep member 111 engages with the central depth 126 and the shallow member 112 engages with the side depth 116. As such, the seat 101 moves about the central rail 125 by way of the deep member 111 and central depth 126, so that the seat 101 can be moved from the car “out” towards the car door. Relatedly, the seat 101 moves about the side rails 115 by way of the shallow member 112 and the side depth 116, so as to allow the seat to travel about the side rails 115. The combined movements of the seat 101 about the side rails 115 and central rail 125 allows the caretaker to move the seat 101 about an ellipsoidal path. Deep member 111 and shallow member 112 collective provide for multi-point rotation of carriage 110 (and thus multi-point rotation of seat 101). As an example, the seat 101 is rotated from a rear-facing configuration during travel to a side facing configuration during unloading; during this rotation, seat 101 has the ability to both translate (relative to the base) and rotate (relative to the base). The improved range of motion ensures that other seats or occupants, adjacent to seat 101, are not inadvertently contacted as seat 101 rotates via the child car seat ellipsoidal path system 100. Relatedly, FIG. 5 shows a top view of a child car seat ellipsoidal path system 100 in use with a child car seat 101.

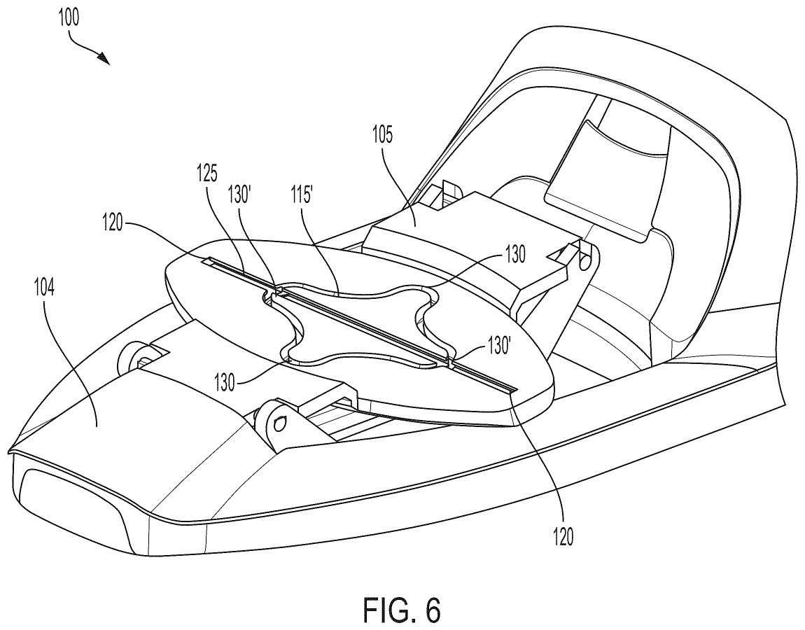

FIGS. 6-10C correspond with a second embodiment of the child car seat ellipsoidal path system 100. This embodiment includes many similar features to that of the first embodiment, such as a carriage 110 slidably coupled to a track member 105. As seen in FIGS. 6-10C the track member 105 for the second embodiment differs from the first embodiment. Specifically, as seen in FIG. 6, the track member 105 includes a single, four-pointed, concave-sided star side rail 115′, rather than the four curvilinear side rails 115. The star side rail 115′ has four rounded points corresponding with four convergence points 130, 130′. As seen in FIG. 6, the central rail 125 bisects the star side rail 115′ at the two convergence points 130′. Moreover, the star side rail 115′ includes two convergence points 130 that are each diagonal from the other two convergence points 130′. Similar to prior disclosure, star side rail 115′ has a side depth and central rail 125 has a central depth (different from side depth); this configuration accommodates two different depth members, such as deep member 111 and shallow member 112, disclosed in greater detail herein.

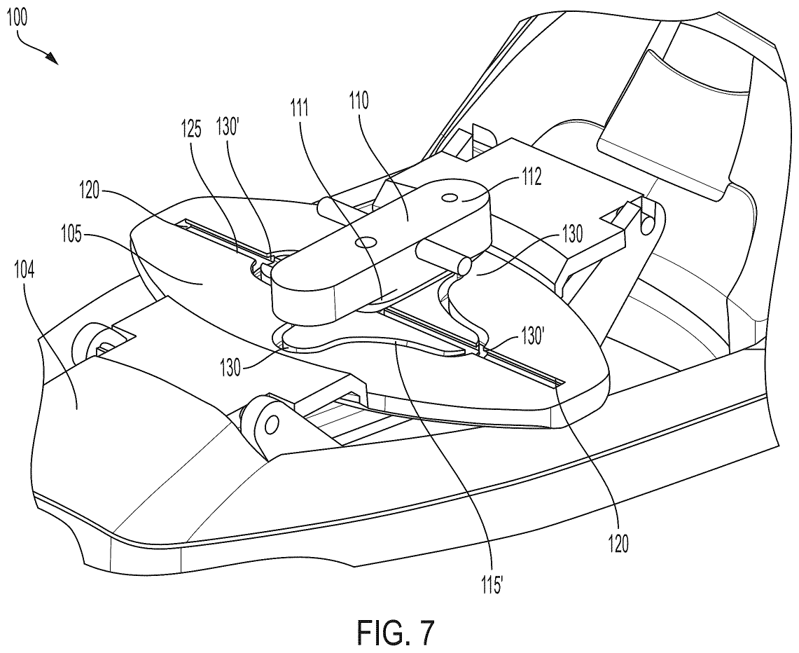

FIG. 7 shows the second embodiment of the child car seat ellipsoidal path system 100 with the carriage 110 movably coupled to the track member 105. Track member 105 is disposed on a base 104 of a car seat.

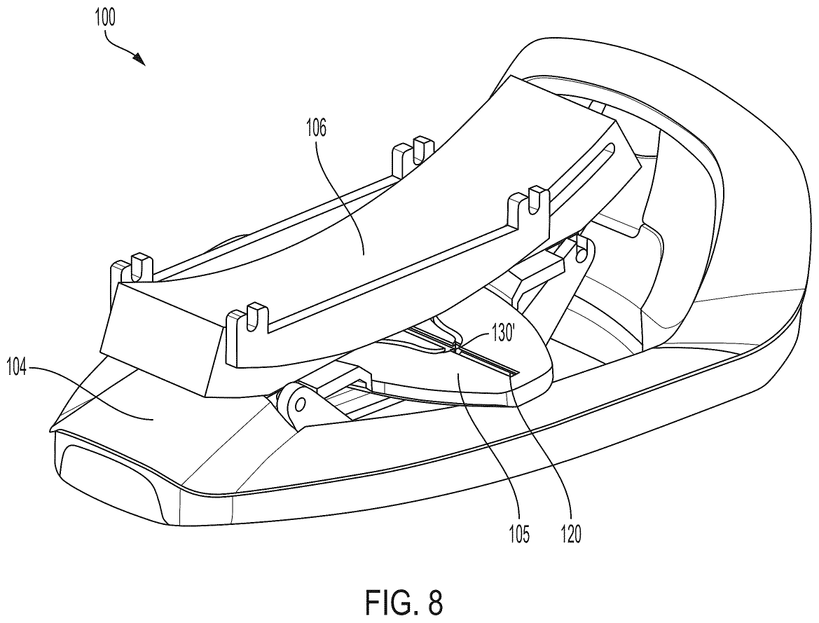

Additionally, FIG. 8 shows the second embodiment of the child car seat ellipsoidal path system 100 with the carriage 110 movably coupled to the track member 105 and, additionally, a seat coupler 106 coupled to the carriage. Notably, a car seat 101 can then selectively couple to the seat coupler 106 (and thus to base 104). It should be appreciated, however, that in alternate embodiments car seat 101 is directly coupled to ellipsoidal path system 100 (i.e., without seat coupler 106).

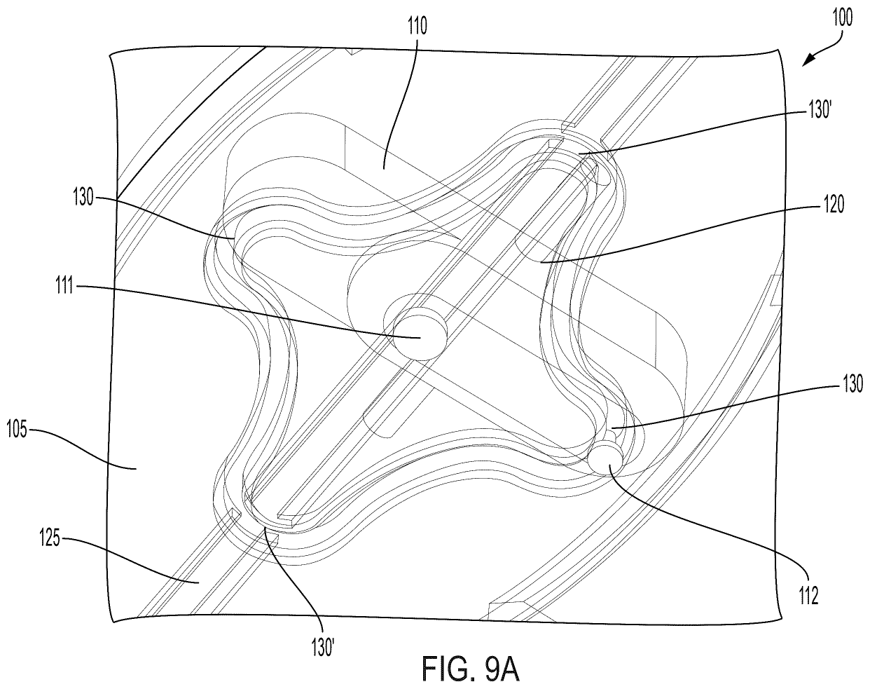

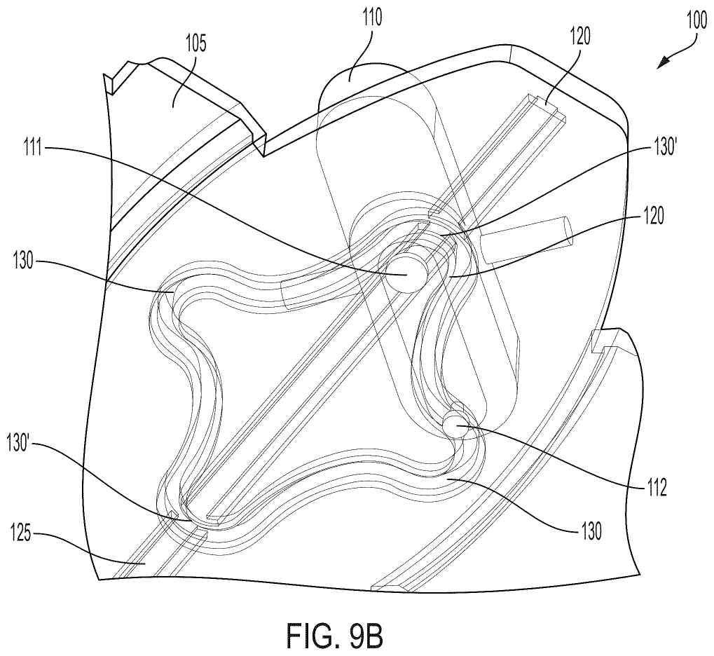

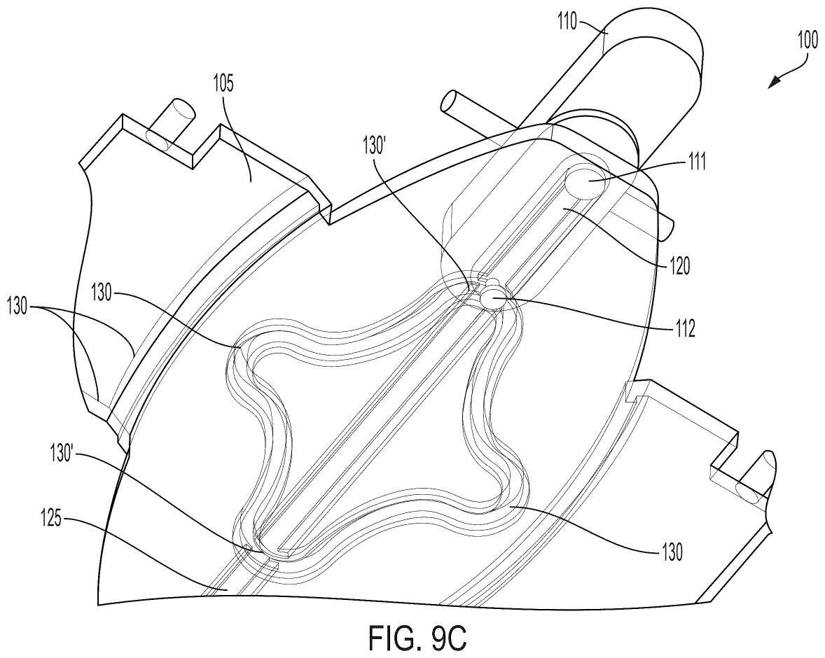

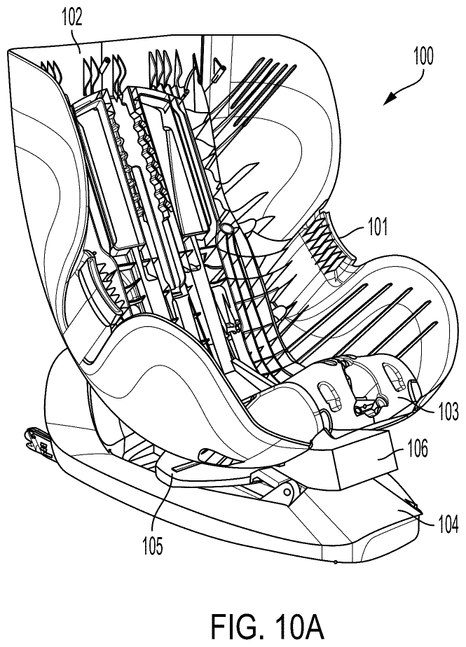

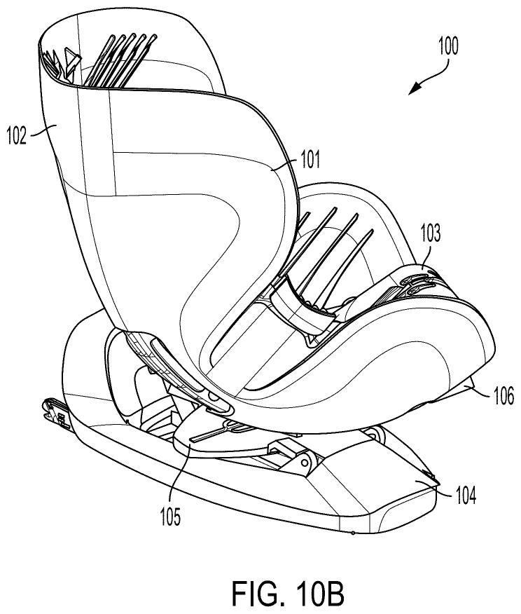

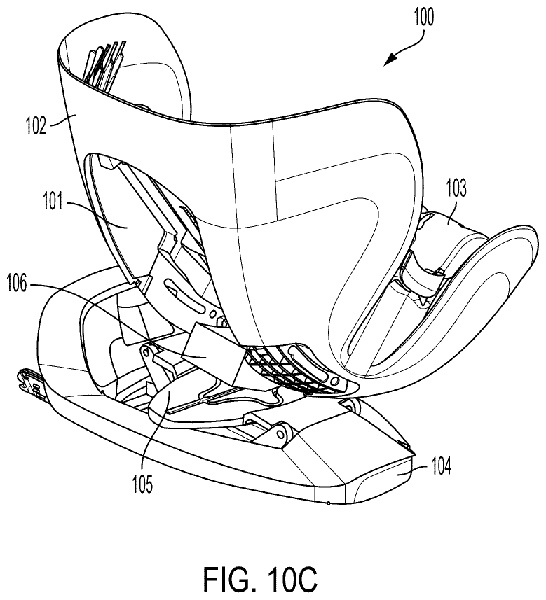

FIGS. 9A-C are bottom-up views of various positional configurations of the carriage 110 coupled to the track member 105. FIG. 9A shows the relative position of the carriage 110 and track member 105 when a child car seat 101 is in a traveling position (as illustrated in FIG. 10A). In this configuration, the deep member 111 is located at the middle point of the central rail 125 and the shallow member 112 is located at one of the two convergence points 130. For example, in the traveling position, the child car seat 101 is ready for transportation in a forward-facing or rear-facing configuration.

FIG. 9B shows a bottom-up view of the configuration of the carriage 110 and track member 105 while the child seat 101 is in a movement position. In this configuration, the deep member 111 moves away from the center of the central rail 125 and the shallow member 112 is not located at any of the convergence points 130, 130′. The configuration shown in FIG. 9B corresponds with the seat position seen in FIG. 10B. For example, in the movement position, the child car seat 101 is being rotated from the traveling position to a loading/unloading position.

FIG. 9C shows a bottom-up view of the configuration of the carriage 110 and track member 105 when the child seat 101 is in a loading/unloading position. In this configuration, the deep member 111 moves away from the center of the central rail 125 to the long end 120 closest to the car door, and the shallow member 112 is located at the convergence point 130′ closest to the car door. The configuration shown in FIG. 9C corresponds with the seat position seen in FIG. 10C. For example, in the loading/unloading position, the child car seat 101 is both rotated towards the caretaker at the car door and translated toward the caretaker at the car door, improving overall access to the child during loading or unloading.

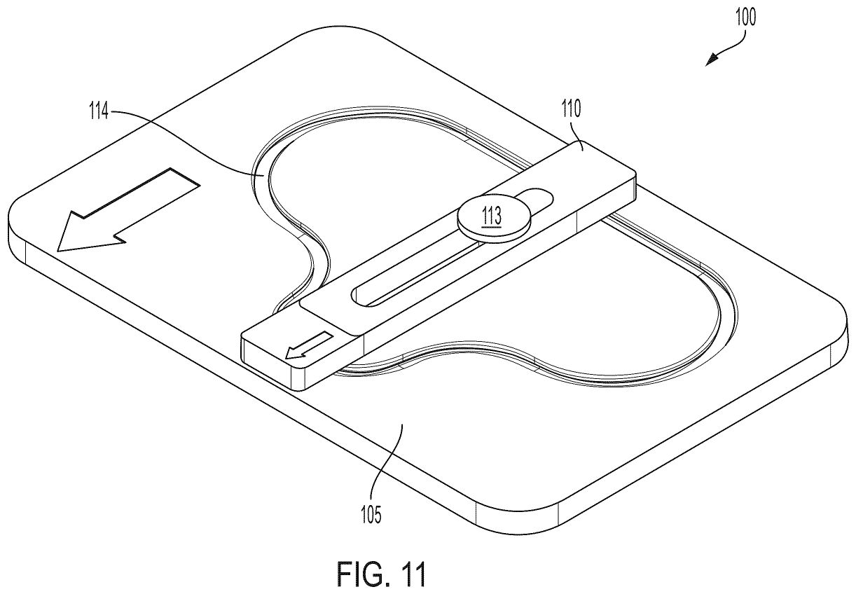

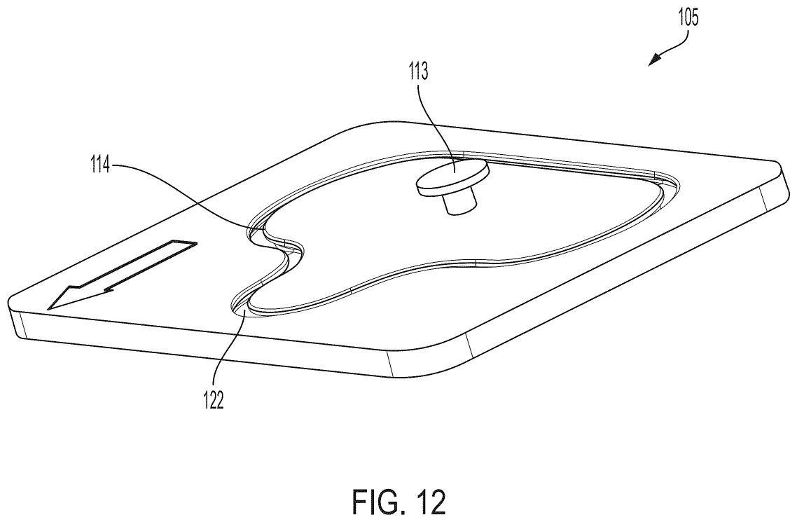

FIGS. 11-14 correspond with a third embodiment of the child car seat ellipsoidal path system 100. This embodiment includes many similar features to that of the first two embodiments, such as a carriage 110 slidably coupled to a track member 105. As seen in FIGS. 11-14 the track member 105 and carriage 110 for the third embodiment differ from the first two embodiments discussed previously above. Specifically, as illustrated by FIGS. 11-12, the track member 105 includes a central post 113. Central post 113 is affixed to track member 105. In an example embodiment, central post 113 is integrally formed with track member 105. For example, central post 113 is a portion of track member 105 formed via injection molding. Carriage 110 is configured to be slidably coupled to central post 113 (as discussed in greater detail herein).

Track member 105 includes an elliptical or oblong track 114. For example, track 114 is generally oval shaped, with a circular portion extending from a side of the generally oval shape. For example, this particular configuration of track 114 may ensure that the occupant of a car seat has the ability to travel “closer” to the caregiver at the side door of the vehicle for improved accessibility during loading and unloading.

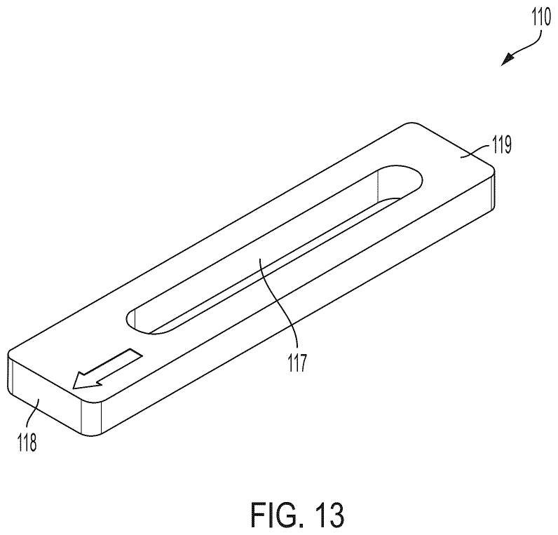

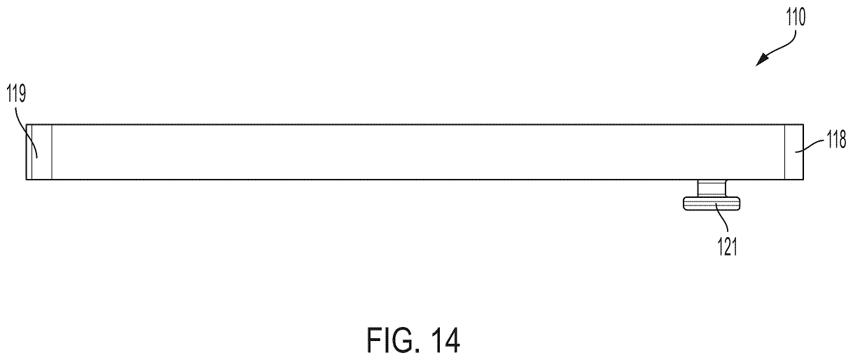

Continuing on, particularly with reference to FIGS. 13-14, carriage 110 may be generally rectangular in shape, have a first end 118 and a second end 119. Carriage 110 may additionally include a slot 117 that extends from a first surface of carriage 110 to a second surface of carriage 110, such that slot 117 is a through-slot. Slot 117 may generally extend in a direction from the first end 118 to the second end 119, such that slot 117 is generally parallel with a length of rectangular carriage 110. Slot 117 is dimensioned so as to receive central post 113. Namely, carriage 110 is configured to be both rotatable about and slidable relative to central post 113 when central post 113 is disposed within slot 117.

As illustrated specifically by FIG. 14, carriage 110 additionally includes a member 121 disposed along a bottom surface of carriage 110. In an example embodiment, member 121 is disposed near the first end 118 of carriage 110; it should be appreciated, however, that member 121 could alternatively be disposed near second end 119 of carriage 110. Returning to FIG. 11, the carriage 110 is moveably coupled to the track member 105. Specifically, member 121 of the carriage 110 is slidably coupled to track 114 and central post 113 is disposed within slot 117 of carriage 110. In this configuration, carriage 110 is slidable along track 114. It should be appreciated that, in an embodiment, member 121 is “lockable” in a given position along track 114. Namely, when in an “unlocked” state, member 121 of carriage 110 freely slides within the track 114; in a “locked state, member 121 is fixed at a given position within the track 114, such that member 121 cannot slide in the “locked” state.

It should be appreciated that a car seat couple and/or a carriage may be selectively coupled to carriage 110.

The many features and advantages of the present disclosure are apparent from the written description, and thus, the appended claims are intended to cover all such features and advantages of the disclosure. Further, since numerous modifications and changes will readily occur to those skilled in the art, the present disclosure is not limited to the exact construction and operation as illustrated and described. Therefore, the described embodiments should be taken as illustrative and not restrictive, and the disclosure should not be limited to the details given herein but should be defined by the following claims and their full scope of equivalents, whether foreseeable or unforeseeable now or in the future.

1. A child car seat system, comprising:
a base;
a child seat; and
an ellipsoidal path system, the ellipsoidal path system including at least:
a track member, affixed to the base, and
a carriage, affixed to the child seat,
wherein the carriage is configured to translate and rotate relative to the track member.

2. The child car seat system of claim 1, wherein the carriage includes a first vertical member and a second vertical member, wherein each of the first vertical member and the second vertical member are configured to slidingly engage with the track member.

3. The child car seat system of claim 2, wherein the first vertical member and the second vertical member have different lengths, such that the first vertical member engages with the track member at a first height and the second vertical member engages with the track member a second height, different from the first height.

4. The child car seat system of claim 2, wherein the track member includes four side rails that collectively form a concave square shape.

5. The child car seat system of claim 4, wherein a cross rail bisects the concave square shape.

6. The child car seat system of claim 2, wherein the track member includes a four-pointed, concave-sided star shape.

7. The child car seat system of claim 6, wherein a cross rail bisects the four-pointed, concave-sided star shape.

8. The child car seat system of claim 1, wherein the carriage is lockable, relative to the track member, such that, when locked, the carriage cannot translate or rotate relative to the track member.

9. The child car seat system of claim 1, wherein the child seat is configured to rotate from a front-facing or rear-facing position to a side-facing position.

10. The child car seat system of claim 9, wherein, when the child seat rotates, the child seat also translates toward a loading position, and wherein translation toward a loading position is in a direction normal to the direction of vehicular travel.

11. The child car seat system of claim 1, wherein the carriage includes a slot, extending from a first end of the carriage to a second end of the carriage.

12. The child car seat system of claim 11, wherein the slot is configured to receive a post disposed along the track member.

13. The child car seat system of claim 12, wherein the track member is oval shaped, with a circular portion extending from a side of the oval shape.

14. A child car seat system, comprising:
a child seat; and
an ellipsoidal path system, the ellipsoidal path system including at least:
a track member having a post, and
a carriage, affixed to the child seat, wherein the carriage includes a slot, extending from a first end of the carriage to a second end of the carriage, and wherein the slot is configured to receive the post.

15. The child car seat system of claim 14, wherein the carriage is configured to translate and rotate relative to the track member.

16. The child car seat system of claim 14, wherein the carriage is lockable, relative to the track member, such that, when locked, the carriage cannot translate or rotate relative to the track member.

17. The child car seat system of claim 14, wherein the child seat is configured to rotate from a front-facing or rear-facing position to a side-facing position.

18. The child car seat system of claim 17, wherein, when the child seat rotates, the child seat also translates toward a loading position, and wherein translation toward a loading position is in a direction normal to the direction of vehicular travel.

19. The child car seat system of claim 14, wherein the track member is oval shaped, with a circular portion extending from a side of the oval shape.

20. The child car seat system of claim 14, wherein the carriage includes a first vertical member configured to slidingly engage with the track member.
